(19) United States
(12) Patent Application Publication
(10) Pub. No.: US 2017/0044038 A1
(43) Pub. Date: Feb. 16, 2017

(54) Electrical Household Appliance with Biodegradable Scale-Inhibiting Agent

(71) Applicant: SEB S.A., Ecully (FR)

(72) Inventors: Olivier Horner, Thiais (FR); Helene Cheap-Charpentier, Paris (FR); Ermane Pourmohtasham, Montrouge (FR); Dominique Gelus, Pont-Eveque (FR); Nathalie Pecoul, Lyon (FR)

(73) Assignee: SEB S.A., Ecully (FR)

(21) Appl. No.: 15/303,835

(22) PCT Filed: Mar. 31, 2015
(86) PCT No.: PCT/FR2015/050840

§ 371 Date: Oct. 13, 2016

(30) Foreign Application Priority Data
Apr. 15, 2014 (FR) 1453381

(51) Int. Cl. C02F 5/10; D06F 75/16; D06F 75/14; D06F 75/18; D06F 39/00

(52) U.S. Cl. CPC C02F 5/10; D06F 75/18; D06F 39/008; D06F 75/14; D06F 75/16; C02F 2307/12

(57) ABSTRACT

Provided is an electrical household appliance (1) have a water tank (2) and a water supply system (4) communicating with the tank, at least one scale-inhibiting agent and means (3) for boiling and/or evaporating the water coming from the reservoir or contained in the reservoir. The scale-inhibiting agent is a biodegradable agent that is at least partially water-soluble. Also provided is a method for inhibiting the formation and deposition of scale in electrical household appliances in contact with an aqueous medium, the method employing said biodegradable scale-inhibiting agent.

This invention relates to the general technical field of electrical household appliances and more precisely concerns appliances having a water tank and means for boiling and/or vaporizing the water coming from the tank, in which a biodegradable scale-inhibiting agent that is at least partially soluble in water is used to prevent the formation and deposition of scale.

This invention also concerns a method for inhibiting the formation and deposition of scale in electrical household appliances in contact with an aqueous medium as well as a method for limiting the accumulation of dry extracts built up in a steam generator, these methods employing a biodegradable scale-inhibiting agent that is at least partially soluble in water.

In the sense of this invention, biodegradable substance is understood to mean any substance capable of being decomposed by microorganisms. The result is the formation of water, carbon dioxide, and/or methane, and possibly by-products (residues, biomass) that are non-toxic to the environment.

In the sense of this invention, electrical household appliances having a water tank and means for boiling and/or vaporizing the water coming from the tank and usable in the scope of this invention are understood to mean appliances having a metal, ceramic, or plastic water tank in which a cold or hot aqueous medium circulates or resides on the one hand, and means for boiling and/or vaporizing the water coming from the tank (for example, a steam chamber in a clothes iron or a heating resistor in a kettle) on the other hand.

As examples of appliances fitting this definition, mention is made of laundry care appliances such as steam irons, steam generator irons, and other appliances that generate steam for ironing (in particular pump-operated steam systems and vertical clothes steamers), steam ovens, steam cookers, sterilizers, fountains dispensing cold water or hot water, coffee makers, tea makers, kettles, steam vacuum cleaners, household appliances for tap water treatment, water flossers, personal care appliances such as steam hair straighteners.

In the sense of this invention, scale is understood to mean any deposit consisting essentially of calcium carbonate (CaCO₃) that forms solid particles or coatings in diverse places on metal, ceramic, or plastic surfaces that are in contact with water, and which are likely to diminish the performance of a given appliance and lead to premature aging of certain parts, thus shortening the useful life of the appliance, or which are likely to create particles that are bothersome to consumers.

In the sense of this invention, scale-inhibiting agent is understood to mean any substance capable of inhibiting the formation of scale, either by hindering the precipitation of calcium carbonate or by slowing the precipitation kinetics thereof once precipitation has started.

Scale formation is a major problem in many industries and household facilities. The use of effective inhibitors (often called “scale-inhibiting agents”) can prolong the useful life of appliances and equipment.

Various means have already been proposed for eliminating or at least reducing the deposition of scale in electrical household appliances, particularly in clothes irons or coffee makers. Accordingly, devices are known for treating water in order to inhibit the precipitation of scale by chemical means prior to steam generation. However, these devices have the major disadvantage of requiring the addition of an acid product that is not easy to handle.

Also known is the use of polyphosphates or of sodium hexametaphosphate (SHMP), because these slow the growth of CaCO₃ crystals (as illustrated in International Patent Application WO 98/28485 and in European Patent EP 1 146 164). However, the effect of these polyphosphates has not been demonstrated in a steam generator in which the vessel concentrates the minerals at a temperature of 140° C.

The phosphonates have an action similar to that of the polyphosphates, but with greater thermal stability. In particular, Patents EP 0 610 997 and U.S. 5,507,108 describe the use of phosphonates disposed in the tank of a clothes iron for reducing the formation of lime deposits in the water supply system located between the tank and the steam chamber. However, even though the dissolution of these products in water is slow and enables the iron to have a long useful life, the dissolution is faster at the beginning of use and the effect diminishes too fast for the iron to attain a normal useful life. The recommended products need to be pelletized, a form that is not conducive to controlling dissolution in water and one that makes diverse and complex salt mixtures necessary.

Phosphonocarbonates, carboxyl polymers (as taught by European Patent EP 1 418 253), and aliphatic polyamines are also known for their scale-inhibiting activity.

However, the very use of scale-inhibiting agents impacts the environment, and as a consequence the demand for systems that permit the amounts of scale-inhibiting agents to be controlled (aka controlled release systems) has increased.

Thus International Patent Application WO 98/28485, for example, describes an electrical household appliance in contact with an aqueous medium, having a water circuit passing through a compartment into which a device for the controlled release of a scale-inhibiting agent is introduced. This device is formed by a silicone matrix in which a scale-inhibiting active substance is dispersed. This active substance, which is a phosphate (in particular sodium hexametaphosphate), is released from the silicone matrix in a controlled fashion adapted in relation to the water volume. United States Patent U.S. Pat. No. 5,507,108 describes a clothes iron comprising in particular a system for the metered injection of a phosphonate compound into the tank. Lastly, French Patent FR 2785166 describes a drip-type coffee maker having a water tank supplying a flow-through water heater and a device for treating the water of the tank consisting of a device for micro-dosing an amount of scale-inhibiting agent that is adjusted to the volume of water supplied to the water heater.

However, such systems are complicated, use products known to impact the environment, and sometimes require the user to perform maintenance operations.

The Applicant found out that the introduction of a biodegradable and water-soluble scale-inhibiting agent into the cold water tank of an electrical household appliance alleviates the aforementioned problems while simultaneously improving the user friendliness of the product by reducing the maintenance operations and the impact of the product on the environment. In the case of a steam generator of an iron, for example, the use of such a scale-inhibiting agent frees the consumer from having to perform interventions on the pressure vessel, which is a tedious and intimidating operation that the user most often refuses to perform (at the expense of having scale build up inside the vessel of the steam generator). Another effect of using such an agent is not causing any more discharge of scale particles through the holes in the sole of the iron.

More particularly, the object of this invention is an electrical household appliance having a water tank and a water supply system communicating with said tank, said water tank and perhaps said water supply system comprising at least one scale-inhibiting agent and means for boiling and/or vaporizing water coming from the tank or contained in the tank (for example a steam chamber if the electrical household appliance is a steam generator of a clothes iron or more simply a resistor of an electric kettle).

As electrical household appliances that can be used in the scope of this invention, mention can be made in particular of steam irons, steam generators, steam cleaners, clothes steamers, steam vacuum cleaners, electrical household appliances for treating tap water, steam ovens, steam cookers, sterilizers, water flossers, fountains dispensing cold water or hot water, coffee makers, tea makers, kettles, and also personal care appliances such as steam hair straighteners.

According to the invention, the scale-inhibiting agent is a biodegradable agent that is at least partially and preferably completely soluble in water.

Compared to the scale-inhibiting agents standardly used in the field of electrical household appliances in contact with an aqueous medium (for example, ones based on phosphate derivatives or phosphocarbonates, carboxyl polymers, or aromatic polyamines), the scale-inhibiting agents that can be used in the scope of this invention are at least equally effective and make it possible to dispense with maintenance operations on the vessel. Furthermore, they have less impact on the environment because they are biodegradable and necessarily harmless to humans.

These scale-inhibiting agents are preferably food agents.

The scale-inhibiting agent is present in the water tank at a concentration ranging from 0.5 ppm to 1000 ppm, and preferably from 0.5 ppm to 500 ppm. Below 0.5 ppm, the scale-inhibiting agent would not be effective, whereas above 1000 ppm would entail adding an excessive amount of scale-inhibiting agent to the tank relative to the effect produced.

Advantageously, the scale-inhibiting agent is chosen from the group including aloe vera, polyaspartic acid (PASP), xanthan, humic acid, folic acid, polymaleic acid, polyepoxysuccinic acid, leucine, Gambier extract, olive extract, Paronychia argentea extract, and mixtures thereof.

Obviously, in the case in which the scale-inhibiting agent is made from plants such as the olive tree, the Gambier, and Paronychia argentea, the active principles of these plants may also be used in purified form to obtain greater efficacy.

Preference is given to using a mixture of aloe vera and polyaspartic acid (PASP) as a scale-inhibiting agent.

The scale-inhibiting agent of the invention can counteract the formation of scale according to several possible modes of action (formation rate, crystallographic structure, size, etc.), alone or in combination with each other:
it can hinder the precipitation of calcium carbonate (CaCO₃) crystals, for example by modifying their shape (which can impede their development),
it can lower the precipitation kinetics of CaCO₃ once precipitation has started,
the final size of the crystals can also be altered, which can impede the transport and deposition of visible particles on the laundry.

For example, combining a scale-inhibiting agent that hinders the formation of CaCO₃ crystals with another scale-inhibiting agent that acts on the formation kinetics thereof is conceivable.

Consequently, another object of this invention is a method for inhibiting the formation and deposition of scale in an electrical household appliance in contact with an aqueous medium, characterized in that said method comprises introducing and then diffusing 0.5 ppm to 1000 ppm, preferably 0.5 ppm to 500 ppm, of a water-soluble, biodegradable scale-inhibiting agent in said aqueous medium to be treated, with the aim of inhibiting the germination and/or the growth of calcium carbonate (CaCO₃) crystals therein.

Still another object of this invention is a method for limiting the accumulation of particles in a boiler such as a kettle or for limiting the accumulation of dry extracts in a flash steam generator such as the sole of an iron, characterized in that said method comprises introducing and then diffusing 0.5 ppm to 1000 ppm, preferably 0.5 ppm to 500 ppm, of a water-soluble, biodegradable scale-inhibiting agent in the water, with the aim of inhibiting the precipitation kinetics of calcium carbonate (CaCO₃) therein.

Regardless of the method envisioned (i.e., whether for inhibiting the formation and deposition of scale in an electrical household appliance or for limiting the accumulation of dry extracts built up in a steam generator or a boiler), the scale-inhibiting agent may preferably be introduced into the aqueous medium in liquid form, wherein said introduction can be done by microdosing in a manual or automatic mode, for example.

But it is also possible to introduce the scale-inhibiting agent into the aqueous medium in solid form, for example in a sustained release matrix, or diluted in a porous structure, or even in the form of a solid disposed at the inlet of the tank and acting by diffusion in the aqueous medium.

The electrical household appliance is an appliance as defined in the preceding.

Other advantages and unique features of this invention will emerge from the following description, which is given as a non-limiting example and which refers to the appended figures, wherein:

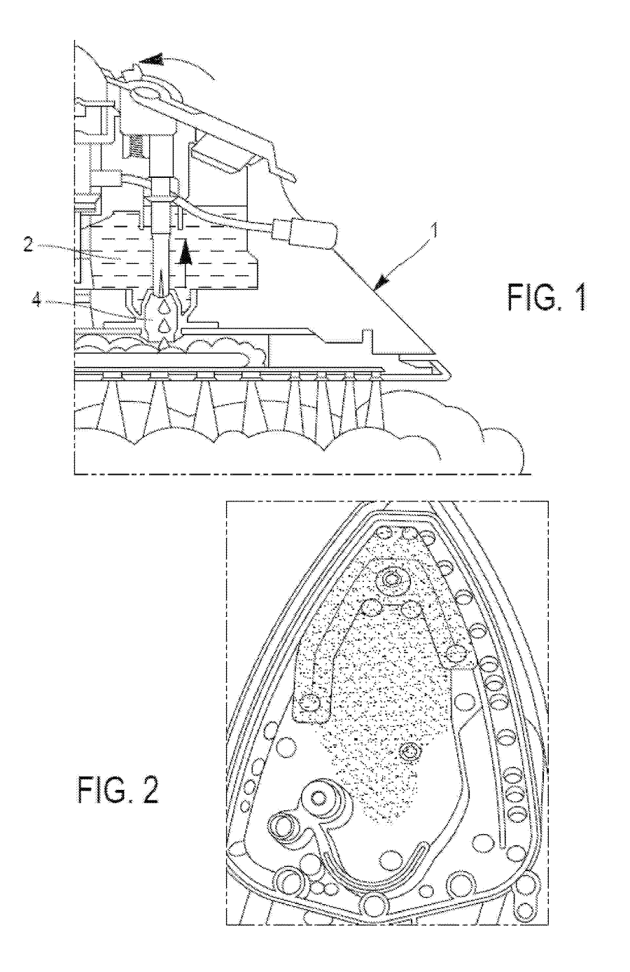

FIG. 1 is a schematic sectional view of a standard steam iron with a flash steam chamber, which is used to carry out the test on the accelerated endurance bench described below,

FIG. 2 is a photograph of the interior of the steam chamber of the sole of the iron of FIG. 1, after a test on an accelerated endurance bench comprising the passage of 40 liters of tap water (with a hardness of 27° F.), without scale-inhibiting agent (temperature of the sole ca. 200° C.),

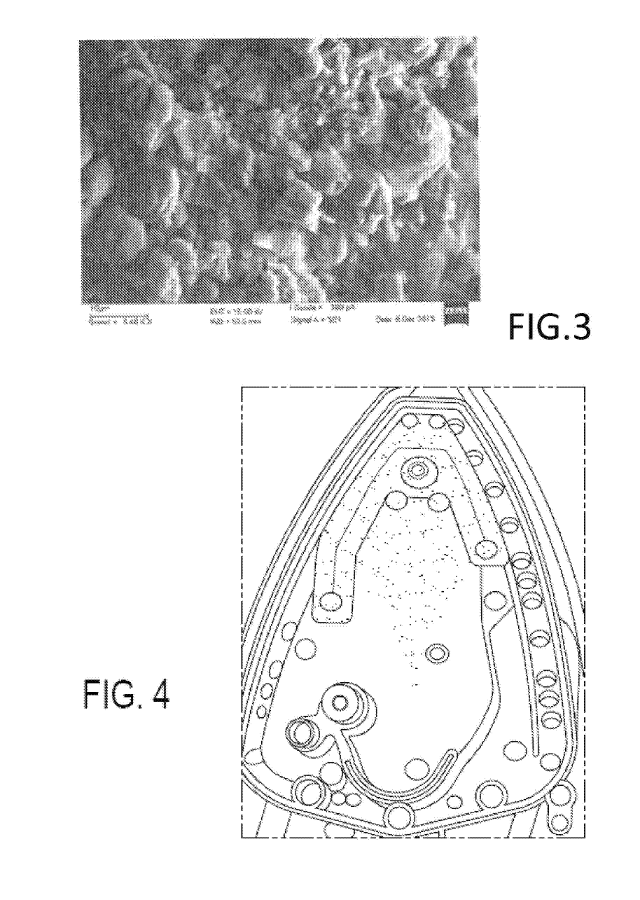

FIG. 3 is a scanning electron microscope (SEM) image showing in detail a scale-coated zone of the interior of the steam chamber of the sole of the iron illustrated in FIG. 2,

FIG. 4 is a photograph of the interior of the steam chamber of the sole of the iron of FIG. 1, after the test on an accelerated endurance bench comprising the passage of 40 liters of tap water (with a hardness of 27° F.), to which was added a scale-inhibiting agent according to a first embodiment of this invention,

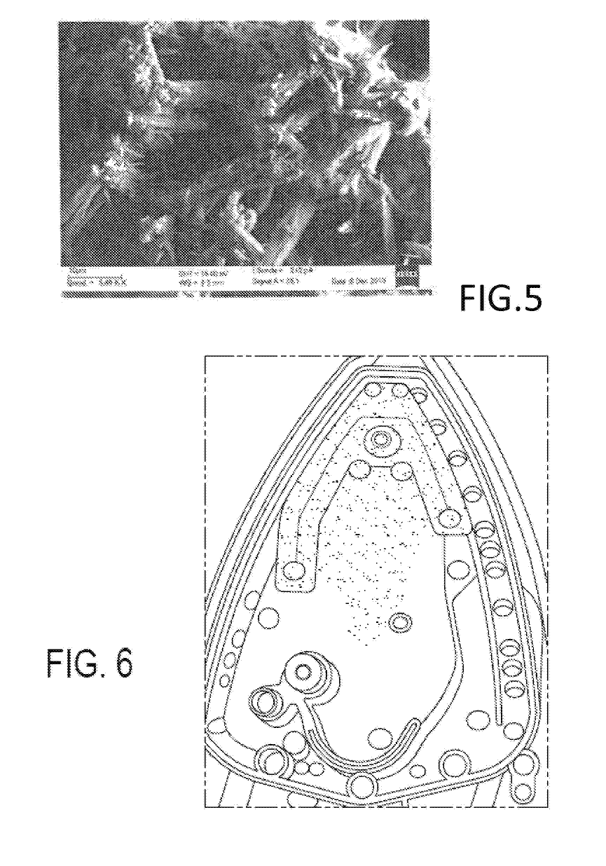

FIG. 5 is a scanning electron microscope (SEM) image showing in detail a scale-coated zone of the interior of the steam chamber of the sole of the iron illustrated in FIG. 4,

FIG. 6 is a photograph of the interior of the steam chamber of the sole of the iron of FIG. 1, after the test on an accelerated endurance bench comprising the passage of 40 liters of tap water (with a hardness of 27° F.), to which was added another scale-inhibiting agent according to a second embodiment of the method of the invention,

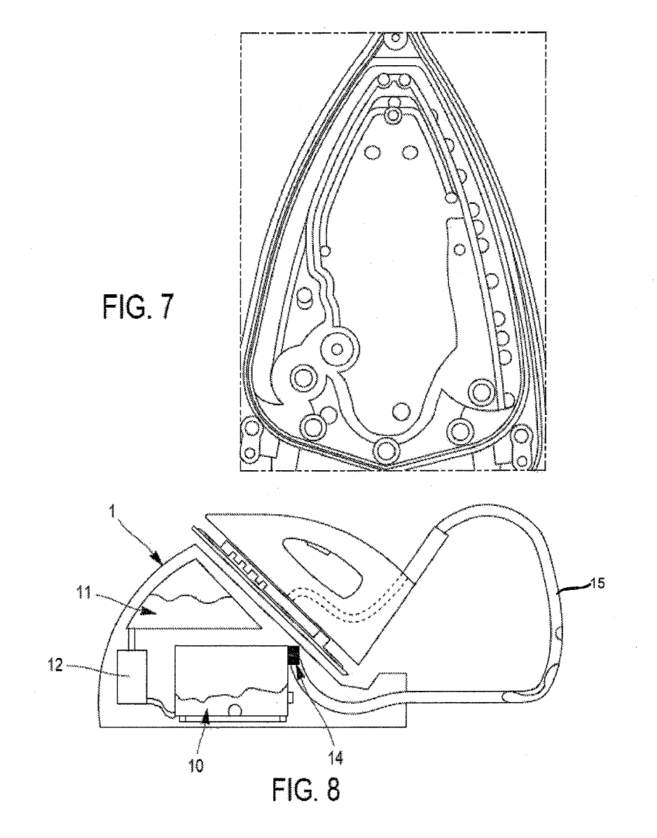

FIG. 7 is a photograph of the interior of the steam chamber of the sole of the iron of FIG. 1, after a use with tap water (with a hardness of 27° F.), to which was added a standard (prior art) polyphosphate scale-inhibiting agent,

FIG. 8 is a schematic sectional view of an iron with a separate steam generator, which is used to perform the generator endurance test described below,

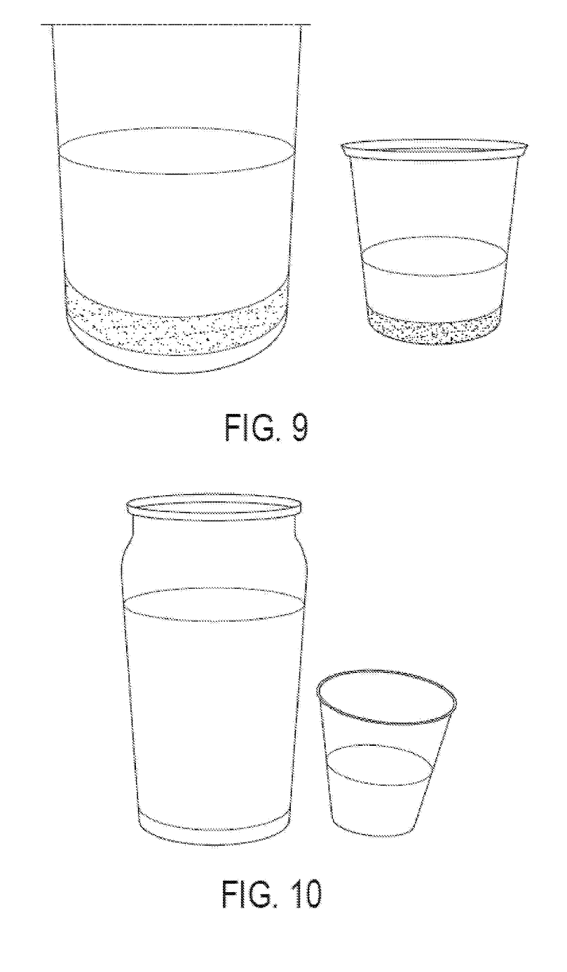

FIG. 9 is a photograph showing:
in the large container, the appearance of water coming from the stainless steel vessel of the iron of FIG. 1, which was collected after a generator endurance test, and
in the small container, the accumulation of precipitates leaving the vessel via the solenoid valve, in the case where the water initially introduced into the tank of the steam generator did not contain any scale-inhibiting agent,

FIG. 10 is a photograph showing:
in the large container, the appearance of water coming from the stainless steel vessel of the iron of FIG. 1, which was collected after a generator endurance test, and
in the small container, the accumulation of precipitates leaving the vessel via the solenoid valve, in the case where the water initially introduced into the tank of the steam generator contains a biodegradable scale-inhibiting agent according to this invention.

### EXPERIMENTAL PROTOCOL OF THE TEST ON THE ACCELERATED ENDURANCE BENCH

This endurance test is performed on an accelerated endurance bench.

The steam iron illustrated in FIG. 1 is used to perform this test. This steam iron 1 comprises a water tank 2 and a water supply system 4 communicating with the tank 2. The steam iron 1 further comprises heating means for boiling and/or vaporizing and/or heating the water coming from the tank 2 or contained in the tank 2.

The endurance test on the accelerated endurance bench consists of injecting, in alternating cycles of 10 seconds of operation and 10 seconds of standstill, 40 liters of tap water (with a hardness of 27° F.), at the rate of 30 g/min into the steam chamber of the sole of the iron, which remains in static mode in order for the deposits to build up. The water from the water tank falls directly into the hot sole of the iron and is instantaneously turned to steam.

The results of this test are illustrated in FIGS. 2 through 7, which are discussed in the results table (Table 1) below.

TABLE 1

| | Appearance of the interior of | |
|---|---|---|
| Nature of the | the aluminum steam | |
| tap water | chamber | Appearance of the scale crystals |
| Without scale- | FIG. 2 (without scale- | FIG. 3 (without scale- |
| inhibiting agent | inhibiting agent) | inhibiting agent) |
| | More than half of the surface of | The presence of cubic crystals of |
| | the steam generation zone is | calcite (stable crystalline structure |
| | coated with scale. | of calcium carbonate), which |
| | A thick layer of scale can be | adhere to each other, can be |
| | seen. The iron can no longer | observed. Few crystals detach |
| | generate steam. | from the wall. |
| With scale- | FIG. 4 | FIG. 5 |
| inhibiting agent | (4 ppm polyaspartic acid) | (4 ppm polyaspartic acid) |
| of the invention | The steam generation zone is | The shape of the crystals is |
| | coated with scale to a much | changed by the presence of |
| | lesser degree than in FIG. 2. | 4 ppm polyaspartic acid: free |
| | The presence of non-adhering | particles in the shape of needles |
| | lime particles can be noted. | (different crystalline structure |
| | The sole can accept water, | than calcite: aragonite) can be |
| | especially since the particles are | seen. |
| | intended to be expelled during | |
| | actual ironing. | |
| | FIG. 6 | |
| | (2 ppm polyaspartic acid and | |
| | 3 ppm aloe vera) | |
| | As in FIG. 4, the steam | |
| | generation zone is coated with | |
| | scale to a much lesser degree | |
| | than in FIG. 2. The presence | |
| | of non-adhering lime particles | |
| | can be noted. The crystals | |
| | detach in the form of | |
| | chips that are much | |
| | larger than in the preceding. | |
| | FIG. 7 | |
| | (40 ppm polyphosphate) | |
| | The steam generation zone is | |
| | coated with scale to a lesser | |
| | degree than with untreated | |
| | water (cf. FIG. 2) but to a | |
| | greater degree than with | |
| | water treated with polyaspartic | |
| | acid/“green” inhibitor (cf. FIGS. | |
| | 4 and 6). | |

### Experimental Protocol of the Generator Endurance Test

The second endurance test is performed with the aid of an iron with a separate steam generator, as illustrated in FIG. 8.

In standard fashion, the steam generator 1 is composed of a pressure vessel 10 for producing pressurized steam, a water tank 11, and a pump 12. The tank 11 is filled with cold water by the user of the iron, and this cold water is periodically supplied by the pump 12 to the pressure vessel 10, where the water temperature reaches 140° C. The cold water is vaporized in the pressure vessel and the steam is transported to the iron 12 via a power cord 14.

The test consists of vaporizing the water injected with the aid of the pump 12 into the pressure vessel 10 and maintained at a temperature slightly higher than 100° C. 8 liters of water are thus treated.

The results of this test are illustrated in FIGS. 9 and 10, which are discussed below:
FIG. 9 is a photograph showing the appearance of water coming from the vessel collected after the generator endurance test (large bottle) as well as that of the water collected leaving the solenoid valve before reaching the sole of the iron (small bottle), in the case where the water initially introduced into the tank of the steam generator does not contain any scale-inhibiting agent:
it can be noted that the water of the large bottle is turbid due to the presence of suspended scale, and
it can be seen that scale particles have settled on the bottom of both bottles.

FIG. 10 is also a photograph showing the appearance of water coming from the vessel collected after the generator endurance test (large bottle) as well as that of the water collected leaving the solenoid valve before reaching the sole of the iron (small bottle), in the case where the water initially introduced into the tank of the steam generator contains a scale-inhibiting agent according to the method of the invention (2 ppm polyaspartic acid and 300 ppm aloe vera):
it can noted that the water of the large bottle is clear: there is no suspended scale, and
it can be seen that very few, if any, scale particles have settled on the bottom of each of the two bottles.

1. An electrical household appliance having a water tank and a water supply system communicating with the tank, said tank comprising at least one biodegradable scale-inhibiting agent that is at least partially soluble in water and including means for boiling the water coming from the tank wherein said scale-inhibiting agent is present in the water tank at a concentration ranging from 0.5 ppm to 1000 ppm.

2. The appliance according to claim 1, in which the scale-inhibiting agent is present in the water tank at a concentration ranging from 0.5 ppm to 500 ppm.

3. The appliance according to claim 1, in which the scale-inhibiting agent is completely soluble in water.

4. The appliance according to claim 1, in which the scale-inhibiting agent is chosen from the group comprising aloe vera, polyaspartic acid (PASP), xanthan, humic acid, folic acid, polymaleic acid, polyepoxysuccinic acid, leucine, Gambier extract, olive extract, Paronychia argentea extract, and mixtures thereof.

5. The appliance according to claim 4, in which the scale-inhibiting agent is a mixture of aloe vera and polyaspartic acid (PASP).

6. The appliance according to claim 1, wherein said appliance is one chosen from the group consisting of: a steam iron, or a steam generator iron, or a steam cleaner, or a clothes steamer, or a steam vacuum cleaner, or a household appliance for treating tap water, or a steam oven, or a steam cooker, or a sterilizer, or a water flosser, or a fountain dispensing cold water or hot water, or a coffee maker, or a tea maker, or a kettle, or a personal care appliance such as a steam hair straightener.

7. A method for inhibiting the formation and the deposition of scale in an electrical household appliance in contact with an aqueous medium, wherein said method comprises the introduction and then the diffusion of 0.5 ppm to 1000 ppm of a biodegradable scale-inhibiting agent that is at least partially soluble in water in said aqueous medium to be treated.

8. The method according to claim 7, in which said scale-inhibiting agent is introduced into the aqueous medium in liquid form.

9. The method according to claim 7, in which the electrical household appliance is one chosen from the group consisting of: a steam iron, or a steam generator iron, or a steam cleaner, or a clothes steamer, or a steam vacuum cleaner, or a household appliance for treating tap water, or a steam oven, or a steam cooker, or a sterilizer, or a water flosser, or a fountain dispensing cold water or hot water, or a coffee maker, or a tea maker, or a kettle, or a personal care appliance such as a steam hair straightener.

10. The method of claim 7, wherein a concentration of the biodegradable scale-inhibiting agent is 0.5 ppm to 500 ppm in the aqueous medium to be treated.
